(19) United States
(12) Patent Application Publication
(10) Pub. No.: US 2026/0048607 A1
(43) Pub. Date: Feb. 19, 2026

(54) SYSTEM AND METHOD FOR DETECTING FORGERY OR ALTERATION OF IDENTIFICATION CARDS

(71) Applicant: LightVision Inc., Seoul (KR)

(72) Inventors: Jin Ha JEONG, Yongin-si (KR); Moon Soo RA, Bucheon-si (KR); Hea Yun LEE, Suwon-si (KR)

(21) Appl. No.: 19/306,559

(22) Filed: Aug. 21, 2025

Related U.S. Application Data
(63) Continuation of application No. PCT/KR2024/002173, filed on Feb. 20, 2024.

(30) Foreign Application Priority Data
Feb. 21, 2023 (KR) 10-2023-0022663
Feb. 19, 2024 (KR) 10-2024-0023504

(51) Int. Cl. B42D 25/342; B42D 25/309; B42D 25/328

(52) U.S. Cl. CPC B42D 25/342; B42D 25/309; B42D 25/328

(57) ABSTRACT

A computing device includes a communication unit and a data processor configured to receive identification card data transmitted from a user terminal through the communication unit, and detect forgery or alteration of an identification card included in the identification card data by using two or more of a moiré pattern recognizing technology, a hand recognition technology, a facial comparison technology and a holographic technology.

### CROSS-REFERENCE TO RELATED APPLICATIONS

This application is a Bypass continuation of pending PCT International Application No. PCT/KR2024/002173, which was filed on Feb. 20, 2024, and which claims priorities under 35 U.S.C 119(a) to Korean Patent Application No. 10-2023-0022663 filed with the Korean Intellectual Property Office on Feb. 21, 2023 and Korean Patent Application No. 10-2024-0023504 filed with the Korean Intellectual Property Office on Feb. 19, 2024. The disclosures of the above patent applications are incorporated herein by reference in their entirety.

### TECHNICAL FIELD

The disclosure relates to a system and a method for detecting forgery or alteration of identification cards.

### BACKGROUND ART

Identification cards are used for identifying individuals. However, there are frequent cases where the identification cards are forged or altered and misused for criminal activities, as shown in FIG. 1.

### SUMMARY

The disclosure is to provide a system and a method for detecting forgery or alteration of identification cards.

Additionally, the disclosure is to provide a system and a method using technologies for detecting forgery or alteration of identification cards, especially a system and a method of registering bank membership.

Furthermore, the disclosure is to provide a system and a method of classifying information of the identification card.

A computing device according to an embodiment of the disclosure includes a communication unit; and a data processor configured to receive identification card data transmitted from a user terminal through the communication unit, and detect forgery or alteration of an identification card included in the identification card data by using two or more of a moiré pattern recognizing technology, a hand recognition technology, a facial comparison technology and a holographic technology.

A computing device according to another embodiment of the disclosure includes a communication unit; and a data processor configured to receive identification card data from a user terminal through the communication unit and detect forgery or alteration of an identification card included in the identification card data by using a hand recognition technology. Here, the data processor detects joints of a hand holding the identification card through the hand recognition technology and detects the forgery or the alteration of the identification card by using the detected joints.

A computing device according to still another embodiment of the disclosure includes a data processor configured to receive identification card data from a user terminal and detect forgery or alteration of an identification card included in the identification card data by using a moiré pattern recognizing technology, a hand recognition technology, a facial comparison technology or a holographic technology; and a storage unit. Here, the data processor extracts individually an image and a text from the identification card when it is determined through a detected result of the forgery or the alteration that the identification card is valid, classifies respectively the extracted image and the extracted text to plural classes and stores the extracted image and the extracted text based on the classification.

A system and a method for detecting forgery or alteration of identification cards discriminates forgery or alteration of the identification by using a moiré pattern recognizing technology, a hand recognition technology, a facial comparison technology and a holographic technology, thereby detecting accurately the forgery or the alteration of the identification card.

Moreover, the system for detecting forgery or alteration of the identification cards classifies information of the identification card to an image and a text and stores the image and the text based on the classification when it is determined through detection of forgery or alteration of the identification card that the identification card is valid, and thus it is easy to search information later and input information into a specific input field.

### BRIEF DESCRIPTION OF DRAWINGS

Example embodiments of the disclosure will become more apparent by describing in detail example embodiments of the disclosure with reference to the accompanying drawings, in which:

FIG. 1 is a view illustrating an example of forgery or alteration of an identification card;

FIG. 2 is a view illustrating a system for detecting forgery or alteration of an identification card according to an embodiment of the disclosure;

FIG. 3 is a view illustrating a forgery/alteration detecting server according to an embodiment of the disclosure; and

FIG. 4 to FIG. 9 are views illustrating a process of applying plural technologies for detecting forgery or alteration of an identification card according to an embodiment of the disclosure.

FIG. 10 is a view illustrating a process of storing information of an identification card according to an embodiment of the disclosure.

FIG. 11 is a view illustrating an example using a technology for detecting forgery or alteration of an identification card according to an embodiment of the disclosure.

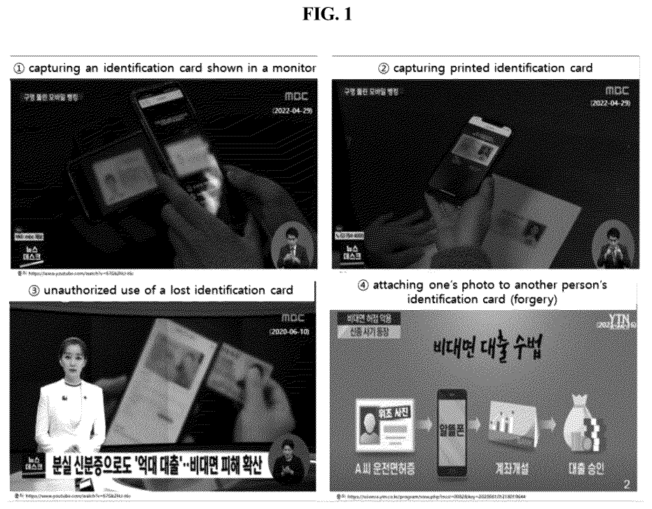

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

The disclosure relates to a system and a method of detecting forgery or alteration of an identification card, and the system and the method may detect accurately and rapidly the forgery or the alteration of the identification card. In this specification, detecting forgery or alteration refers to determining whether an identification card is non-genuine, including forgery, alteration, reproduction, or other invalid forms (collectively, “non-genuine”). The identification card includes all forms of identification that can verify an individual's identity, and it includes for example a resident registration card, a driver's license or a passport, etc.

In an embodiment, the system of the present embodiment may detect the forgery or the alteration of the identification card by using at least two of a moiré pattern recognizing technology, a hand recognition technology, a facial comparison technology and a holographic technology. As a result, the system may detect invalid identification card in various situations such as a monitor capturing, a printed identification card, usage of another person's ID, photo replacement, etc.

Especially, the system may be efficiently used for verifying whether the identification card is valid in various cases such as bank membership registration through an online process, etc. In this view, the disclosure may be referred to as a usage system, e.g. bank membership registration system using technologies for detecting forgery or alteration of the identification card.

In another embodiment, the system may classify information of the identification card to an image and a text when it is determined through detection of the forgery or the alteration of the identification card that the identification card is valid and store the image and the text based on the classification. As a result, it is easy to search information later and input information into a specific input field. Accordingly, the disclosure may be referred to as a system for classifying information of the identification card.

Hereinafter, various embodiments of the disclosure will be described in detail with reference to accompanying drawings.

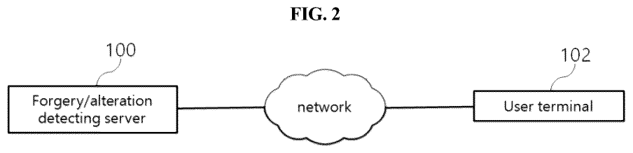

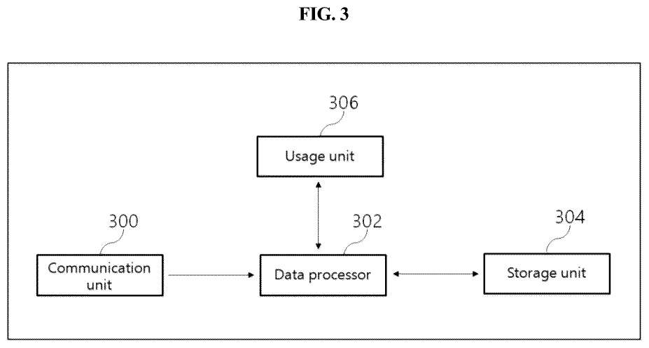

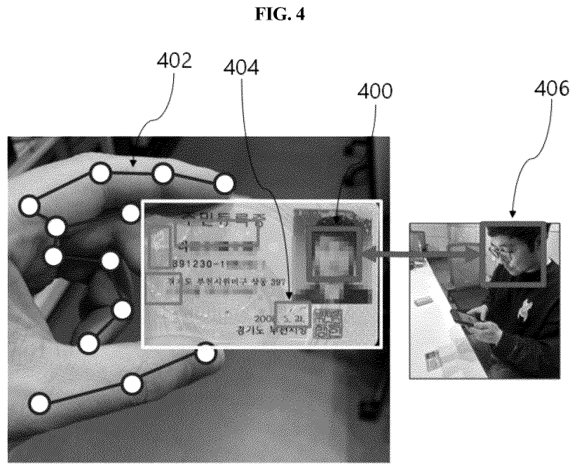

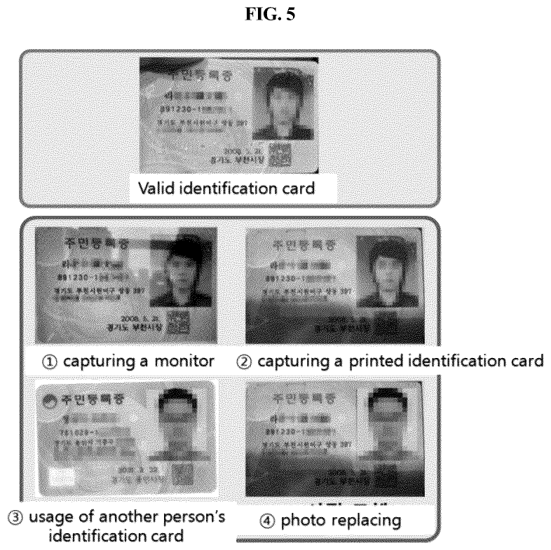

FIG. 2 is a view illustrating a system for detecting forgery or alteration of an identification card according to an embodiment of the disclosure, FIG. 3 is a view illustrating a forgery/alteration detecting server according to an embodiment of the disclosure, and FIG. 4 to FIG. 9 are views illustrating a process of applying plural technologies for detecting forgery or alteration of an identification card according to an embodiment of the disclosure.

In FIG. 2, a system for detecting forgery or alteration of an identification card of the present embodiment may include a forgery/alteration detecting server (computing device) 100 and a user terminal 102.

The forgery/alteration detecting server 100 detects forgery or alteration of an identification card, e.g. captured identification card provided from the user terminal 102 and include a communication unit 300, a data processor 302 and a storage unit 340 as shown in FIG. 2. On the other hand, the forgery/alteration detecting server 100 may further include a usage unit 306 using detection result of forgery or alteration of the identification card.

In an embodiment, the forgery/alteration detecting server 100 may be a terminal installed to a bank, etc., a forgery/alteration detecting program may be installed to the terminal, and the forgery/alteration detecting server 100 may detect the forgery or the alteration of the identification card when it verifies the identification card so as to register membership through an online process, etc.

The communication unit 300 is a communication path with the user terminal 102.

The data processor 302 may detect the forgery or the alteration of the identification card provided from the user terminal 102 through the communication unit 300.

In an embodiment, the data processor 302 may detect the forgery or the alteration of the identification card by using plural technologies of a moiré pattern recognizing technology, a hand recognition technology, a facial comparison technology and a holographic technology.

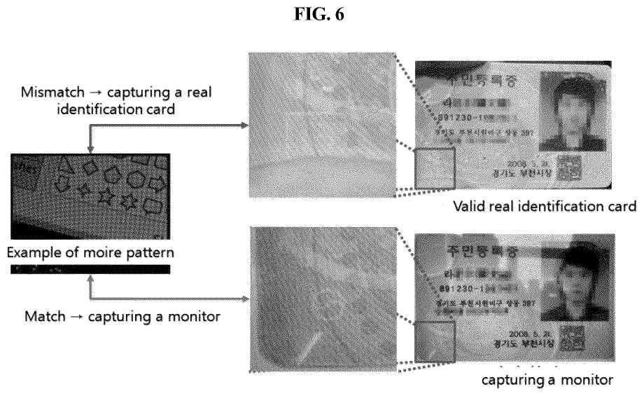

The moiré pattern recognizing technology may verify whether or not moiré pattern exists on a captured identification card. For example, moiré pattern 400 may exist on a part of the identification card as shown in FIG. 4. For example, moiré pattern may occur because pixel array of a display device is different from that of a camera as shown in FIG. 6, when the identification card is displayed on the display device through scanning and then the displayed identification card is captured through the camera. That is, the data processor 302 may detect whether a moiré pattern indicative of display reproduction exists above a threshold and determines non-genuineness based at least in part on the detected pattern.

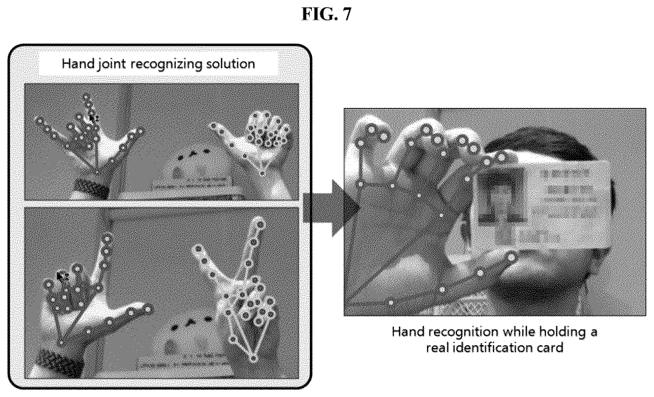

The hand recognition technology may verify whether or not the user has captured a physical identification card while holding the physical identification card with a hand. For example, the hand recognition technology may recognize a joint 402 of the hand holding the identification card as shown in FIG. 4 and verify through analysis of the recognized joint 402 whether the user is holding the identification card. Particularly, the hand recognition technology may recognize joints of the hand as shown in FIG. 7, identify a posture of the hand through the recognized joints and detect through the identified posture whether the user is holding the physical identification card.

It is important to recognize a distance between fingers as well as the posture of the hand. Accordingly, the hand recognition technology may calculate the distance between the joints of the fingers holding the identification card and detect whether or not the calculated distance is matched with a size of the identification card. This is, the data processor 302 may detect the posture of the hand and the distance between the joints through analysis of the joints and discriminate through the detected posture and the detected distance whether the user is holding the physical identification card. Accordingly, the data processor 302 may determine that the identification card is invalid when it discriminates that the user is not holding the physical identification card.

The facial comparison technology may compare a real face 406 with a face of a photograph displayed on the identification card to determine whether the identification card is valid. By utilizing the facial comparison technology, it is possible to detect forgery or alteration, such as the use of another person's identification card or the substitution of the user's photograph on another person's identification card.

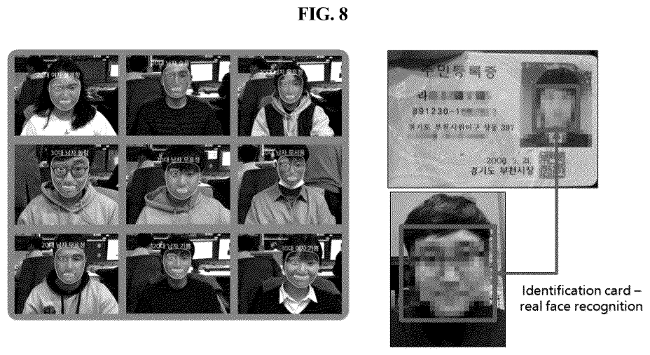

In an embodiment, the data processor 302 may recognize gender/age (age group)/facial expression with detecting real face through the facial comparison technology as shown in FIG. 8. Here, the data processor 302 may determine that the identification card is invalid when any of the face, the gender or the age group does not match the identification card.

For example, the data processor 302 may determine that the identification card is invalid, if a real face is recognized as male but the identification card indicates female even if the recognized face displayed on the identification card is similar to the real face.

For another example, the data processor 302 may determine that the identification card is invalid, if a real face is recognized as being in the 20s but the identification card indicates an age in the 40s even if the recognized face displayed on the identification card is similar to the real face.

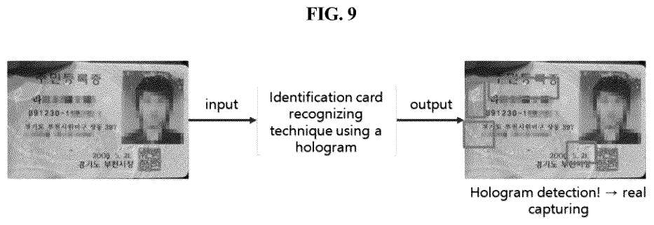

The holographic technology may verify whether preset hologram pattern 404 exists on the captured identification as shown in FIG. 4. Accordingly, the data processor 302 may detect a hologram pattern of the captured identification card using the holographic technology as shown in FIG. 9 and determine that the identification pattern is invalid when the detected hologram pattern is formed on different position not designated position, is different from the preset hologram pattern or is not formed on the designated position. The data processor 302 may detect invalid identification card through verification of the hologram pattern because of the inherent properties of holograph technology, the distinctive features of the hologram, as originally designed, are present only in the original.

That is, the data processor 302 may verify whether the captured identification card is valid, by applying individually the moiré pattern recognizing technology, the hand recognition technology, the facial comparison technology and the holographic technology to the captured identification card.

In an embodiment, the data processor 302 may apply the facial comparison technology after performing sequentially the moiré pattern recognizing technology, the hand recognition technology and the holographic technology. Of course, if the hand recognition technology is omitted, the data processor 302 may apply the facial comparison technology after performing sequentially the moiré pattern recognizing technology and the holographic technology. The foregoing technologies may be applied in any order or in parallel; in some embodiments, they are applied sequentially as described.

The data processor 302 may perform sequentially these technologies, but determine that the captured identification card is invalid without applying a technology following a specific technology when it is discriminated through the specific technology that the captured identification card is invalid. Of course, the data processor 302 may perform all the moiré pattern recognizing technology, the hand recognition technology, the holographic technology and the facial comparison technology even if it is discriminated that the identification card is invalid during the intermediate process. This is to identify what kind of forgery or alteration has been carried out.

The storage unit 304 may store various data such as information concerning the captured identification card or detection result of forgery/alteration and so on. Especially, the storage unit 304 may divide information of the identification card to an image and a text, classify the image and the text into plural classes and store the image and the text based on classification.

The usage unit 306 may utilize the technology for detecting the forgery or the alteration of the data processor 302. For example, the usage unit 306 may proceed with a registration process when it is determined through detection of forgery or alteration of the captured identification card by the data processor 302 that the captured identification card is valid, in a process of registering bank membership.

Briefly, the system for detecting forgery or alteration of the identification card of the present embodiment may detect the forgery or the alteration of the identification card by using the moiré pattern recognizing technology, the hand recognition technology, the facial comparison unit and the holographic technology. As a result, the system may detect various forgery or alteration.

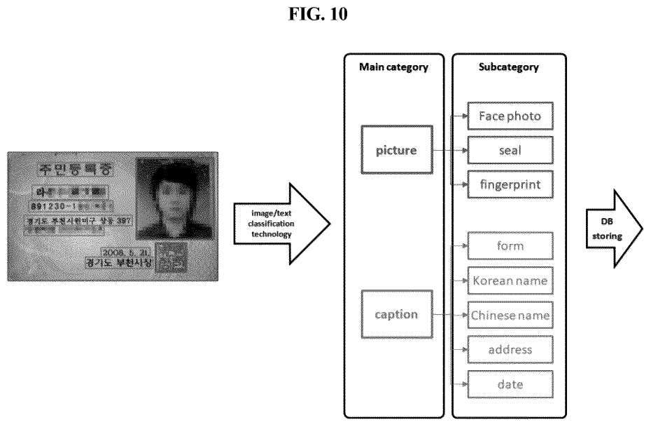

FIG. 10 is a view illustrating a process of storing information of an identification card according to an embodiment of the disclosure.

As shown in FIG. 10, the data processor 302 of the forgery/alteration detecting server 100 may detect the forgery or the alteration of the identification card, classify the information of valid identification card and store the information in the storage unit 304 based on the classification.

In an embodiment, the data processor 302 may extract individually an image (picture) and a text (caption) from the identification card (including front side and back side) when it is determined that the identification card is valid.

Subsequently, the data processor 302 may classify the extracted image to “face photo”, “seal” and “fingerprint” and store the extracted image in the storage unit 304 based on the classification, and classify the extracted text to “form”, “Korean name”, “Chinese (foreign-language) name”, “address” and “date” and store the extracted text in the storage unit 304 based on the classification. Of course, an original image of the identification card may be stored in the storage unit 304, and aforementioned classification reference may be changed.

By classifying and storing the image and text in such detail, it is possible to quickly and accurately search for the desired information later and automatically input the input fields with ease.

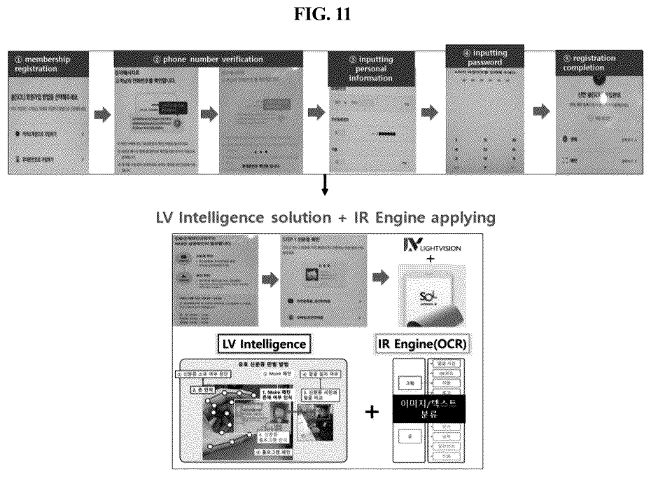

FIG. 11 is a view illustrating an example using a technology for detecting forgery or alteration of an identification card according to an embodiment of the disclosure.

In FIG. 11, a process of detecting forgery or alteration of the identification card and a process of classifying information of the identification card may be performed between a step of verifying phone number and a step of inputting personal information, when registering bank membership.

Particularly, the data processor 302 may detect the forgery or the alteration of inputted identification card according to request of the usage unit 306, extract, classify and store the image and the text of the identification card when it is determined that the identification card is valid.

Subsequently, the usage unit 306 may input automatically allowable information in a personal information input field by using the classified information. Since the image and the text of the identification card are classified into various categories and are stored in the storage unit 304, it is easy to input personal information in the personal information input field.

Components in the embodiments described above can be easily understood from the perspective of processes. That is, each component can also be understood as an individual process. Likewise, processes in the embodiments described above can be easily understood from the perspective of components.

Also, the technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present disclosure or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the present disclosure, and vice versa.

The embodiments of the present disclosure described above are disclosed only for illustrative purposes. A person having ordinary skill in the art would be able to make various modifications, alterations, and additions without departing from the spirit and scope of the present disclosure, but it is to be appreciated that such modifications, alterations, and additions are encompassed by the scope of claims set forth below.

1. A computing device comprising:
a communication unit; and
a data processor configured to receive identification card data transmitted from a user terminal through the communication unit, and detect forgery or alteration of an identification card included in the identification card data by using two or more of a moiré pattern recognizing technology, a hand recognition technology, a facial comparison technology and a holographic technology.

2. The computing device of claim 1, wherein the data processor applies the facial comparison technology to the identification card after applying separately the moiré pattern recognizing technology, the hand recognition technology and the holographic technology to the identification card.

3. The computing device of claim 1, wherein the data processor detects whether or not a moiré pattern exists on the identification card by using the moiré pattern recognizing technology, determines that the identification card is invalid when the moiré pattern exists on the identification card,
detects whether or not a preset hologram exists on the identification card by using the holographic technology, and determines that the identification card is invalid when the preset hologram does not exist on the identification card.

4. The computing device of claim 1, wherein the data processor detects joints of fingers holding the identification card through the hand recognition technology, detects posture of a hand through the detected joints, and determines that the identification card is invalid in an event that the detected posture is not a posture holding the identification card or a distance between corresponding joints is different from a real distance when a user is holding the identification card.

5. The computing device of claim 1, wherein the data processor determines that the identification card is invalid when a face displayed on the identification card is different from a real face.

6. The computing device of claim 5, wherein the data processor detects gender and age group as well as the face by analyzing the real face and determines that the identification card is invalid when the detected gender or the detected age group does not match with gender or age of the identification card even if the face displayed on the identification card is similar to the real face.

7. The computing device of claim 1, further comprising:
a storage unit configured to store information of the identification card or a detected result of forgery or alteration; and
a usage unit configured to utilize the detected result by the data processor,
wherein the information of the identification card is classified to an image and a text and is stored in the storage unit when it is determined that the identification card is valid.

8. A computing device comprising:
a communication unit; and
a data processor configured to receive identification card data from a user terminal through the communication unit and detect forgery or alteration of an identification card included in the identification card data by using a hand recognition technology,
wherein the data processor detects joints of a hand holding the identification card through the hand recognition technology and detects the forgery or the alteration of the identification card by using the detected joints.

9. The computing device of claim 8, wherein the data processor detects a posture of the hand through the detected joints, and determines that the identification card is invalid in an event that the detected posture is not a posture holding the identification card or a distance between corresponding joints is different from a real distance when a user is holding the identification card.

10. A computing device comprising:
a data processor configured to receive identification card data from a user terminal and detect forgery or alteration of an identification card included in the identification card data by using a moiré pattern recognizing technology, a hand recognition technology, a facial comparison technology or a holographic technology; and
a storage unit,
wherein the data processor extracts individually an image and a text from the identification card when it is determined through a detected result of the forgery or the alteration that the identification card is valid, classifies respectively the extracted image and the extracted text to plural classes and stores the extracted image and the extracted text based on the classes.

11. The computing device of claim 10, wherein the data processor classifies the extracted image to “face photo”, “seal” and “fingerprint”, stores the extracted image in the storage unit based on the classes, classifies the extracted text to “form”, “Native-language name”, “foreign-language name”, “address” and “date” and stored the extracted text in the storage unit based on the classes.

12. The computing device of claim 10, further comprising:
a usage unit configured to perform a membership registration process,
wherein the data processor detects the identification card according to request of the usage unit and inputs personal information into a membership registration site using the extracted image and the extracted text when it is determined that the identification card is valid.
